(19) United States
(12) Patent Application Publication
(10) Pub. No.: US 2007/0246632 A1
(43) Pub. Date: Oct. 25, 2007

(54) SUPPORTS

(75) Inventor: Chien Hung Chen, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/735,408

(22) Filed: Apr. 13, 2007

(30) Foreign Application Priority Data
Apr. 14, 2006 (TW) 95113325

(51) Int. Cl. F16M 11/00

(52) U.S. Cl. 248/407

(57) ABSTRACT

Supports are provided. A support comprises a fixed member, a sliding member movable with respect to the fixed member, a slider movable with respect to the sliding member, and a resilient member connecting the fixed member and the sliding member. The fixed member comprises an engaging portion and a pathway around the engaging portion. When the sliding member moves with respect to the fixed member, the slider moves from an original position to a recess of the engaging portion along the pathway, wherein the slider is engaged with the recess by spring force from the resilient member. When the slider is released from the recess, the slider returns to the original position along the pathway by the spring force.

### BACKGROUND OF THE INVENTION

1. Field of the Invention

The invention relates in general to display support and in particular to retractable supports.

2. Description of the Related Art

A conventional flat display is movably connected to a base via a retractable support. The support may comprise a positioning mechanism, such as a latch, to hold the display at a predetermined height. When the latch is released by an external force, the flat display is vertically movable with respect to the base.

### BRIEF SUMMARY OF THE INVENTION

A support comprises a fixed member, a sliding member movable with respect to the fixed member, a slider movable with respect to the sliding member, and a resilient member connecting the fixed member and the sliding member. The fixed member comprises an engaging portion and a closed pathway around the engaging portion. When the sliding member moves with respect to the fixed member, the slider moves from an original position to a recess of the engaging portion along the pathway, wherein the slider is engaged with the recess by spring force from the resilient member. When the slider is released from the recess, the slider returns to the original position along the pathway by the spring force.

### BRIEF DESCRIPTION OF THE DRAWINGS

The invention can be more fully understood by reading the subsequent detailed description and examples with references made to the accompanying drawings, wherein:

FIGS. 1 and 2 are perspective diagrams of a retractable support connecting a flat display and a base;

FIG. 3 is a perspective diagram of a retractable support;

FIG. 4 is a schematic diagram of a slider moving along a closed pathway;

FIG. 5 is a schematic diagram of a slider moving along a first path; and

FIG. 6 is a schematic diagram of a slider moving along a second path.

### DETAILED DESCRIPTION OF THE INVENTION

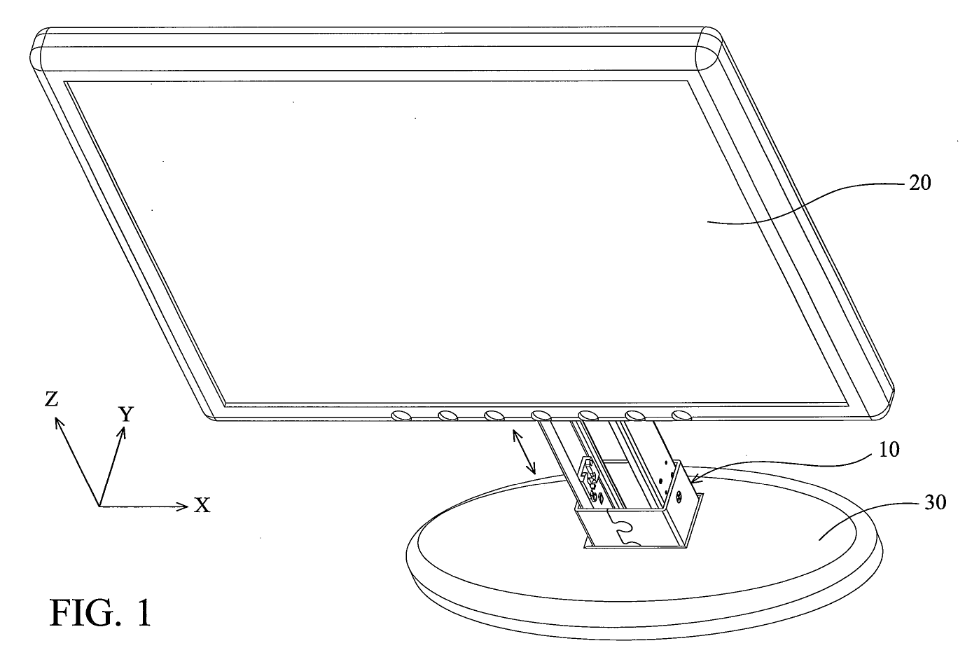

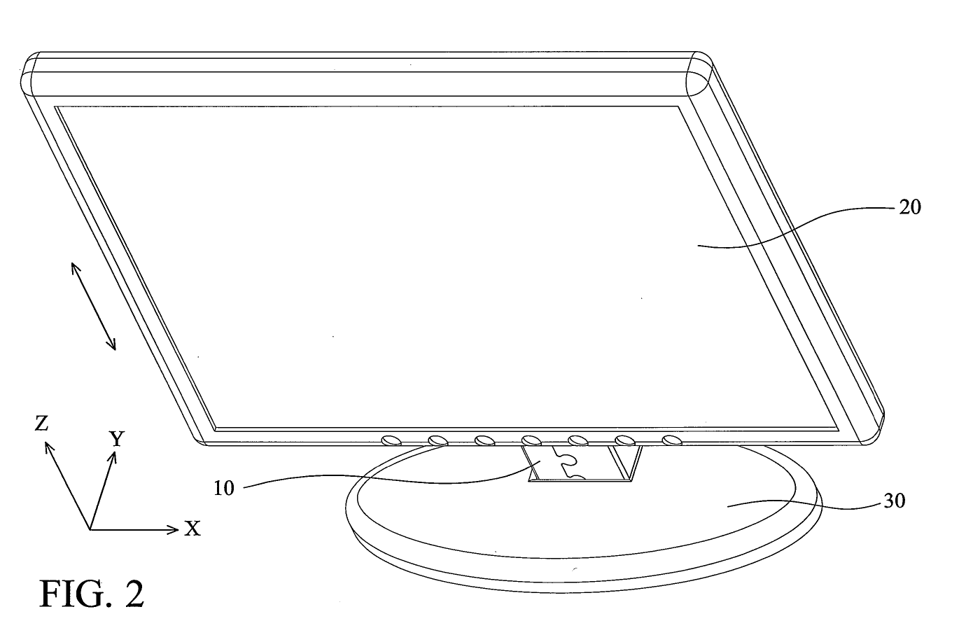

Referring to FIGS. 1 and 2, an embodiment of a flat display 20 with base 30 are connected via a retractable support 10. The flat display 20 is vertically movable along Z axis by the support 10 between a normal state shown in FIG. 1 and a retracted state shown in FIG. 2 to adjust the altitude along Z axis.

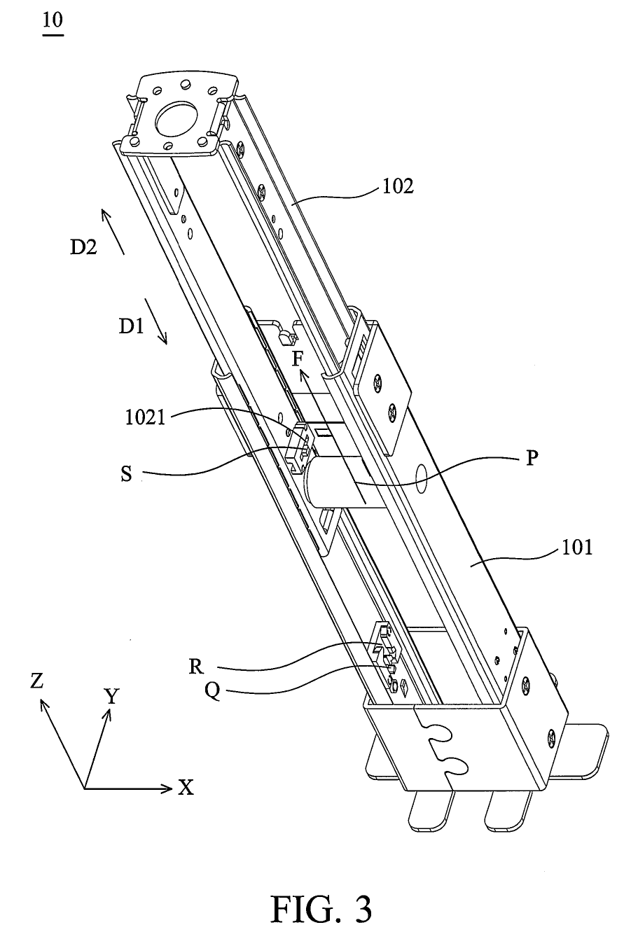

Referring to FIG. 3, the support 10 primarily comprises a fixed member 101, a sliding member 102, a slider S and a resilient member P. The bottom of the fixed member 101 is fixed to the base 30 or a supporting surface. The sliding member 102 is movable with respect to the fixed member 101 in a first direction D1 or a second direction D2, substantially parallel to Z axis. The resilient member P, such as a constant force spring, connects the fixed member 101 and the sliding member 102, and exerts a constant spring force F on the sliding member 102 along the first direction D1. As shown in FIG. 3, the slider S is received in a guiding rail 1021 on an inner surface of the sliding member 102 and movable along Y axis. Specifically, the fixed member 101 comprises an engaging portion Q and a closed pathway R around the engaging portion Q.

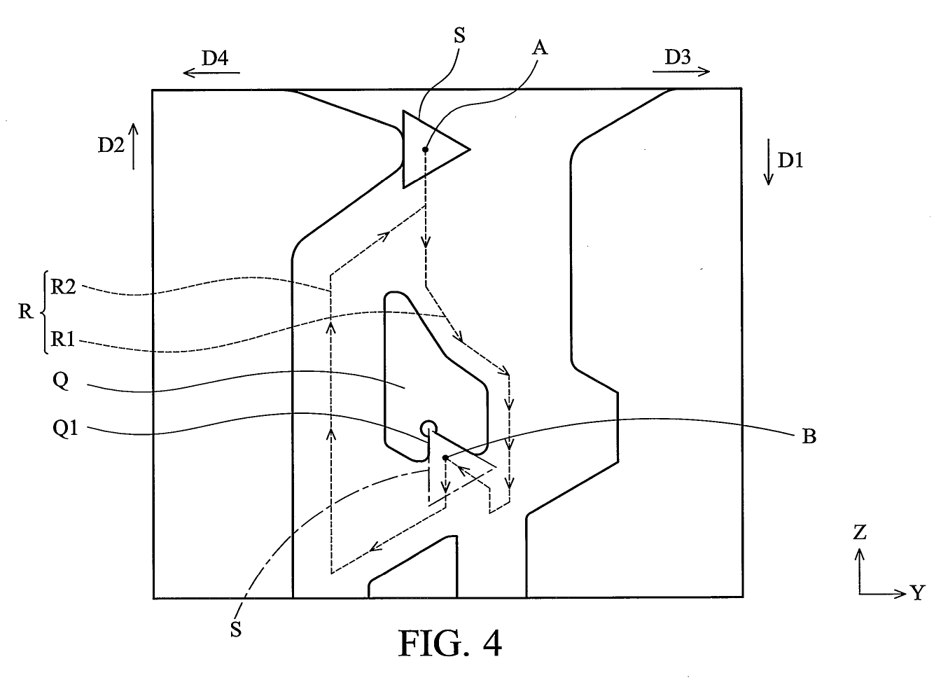

Referring to FIG. 4, the closed pathway R includes a first path R1 and a second path R2. When the support 10 is switched from the normal state shown in FIG. 1 to the retracted state shown in FIG. 2, the sliding member 102 is manually pressed with a first force in the first direction D1, such that the slider S moves from an original position A to a joining position B along the first path R1, as shown in FIG. 4. With the first force released, the slider S is restricted in a recess Q1 of the engaging portion Q by spring force from the resilient member P, such that the support 10 is held in the retracted state, as shown in FIG. 2.

To return the support 10 from the retracted state to the normal state as shown in FIG. 1, the slider S is first removed from the recess Q1 by application of a second force to the sliding member 102 along the second direction D2. Subsequently, with second force released, the spring force F impels the slider S to the original position A along the second path D2, as shown in FIG. 4, such that the support 10 returns to the normal state.

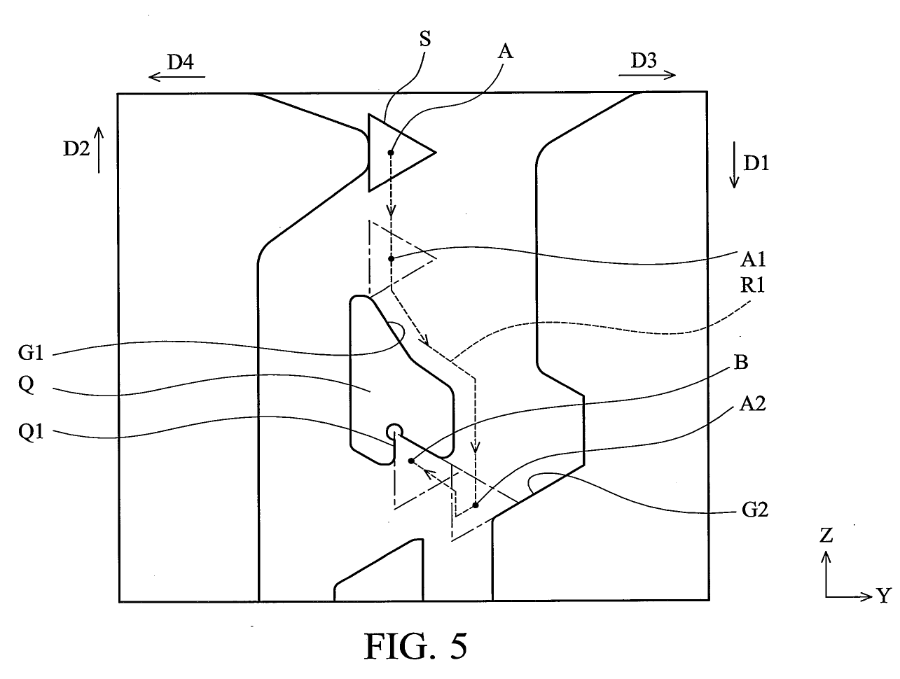

Referring to FIG. 5, when the first force impels the sliding member 102 along the first direction D1 to depress the support 10, the slider S moves from the original position A to position A1. As shown in FIG. 5, the slider S is guided by a first slope G1 of the engaging portion Q along the first path R1, with horizontal movement in a third direction D3 parallel to Y axis. Subsequently, the slider S descends to position A2, and a second slope G2 of the fixed member 101 guides the slider S along the first path R1, with horizontal movement in a fourth direction D4, opposite to the third direction D3. When the first force is released, the slider S is moved from the position A2 to the joining position B and restricted in the recess Q1 by the spring force F along the second direction D2, such that the support 10 is held in the retracted state.

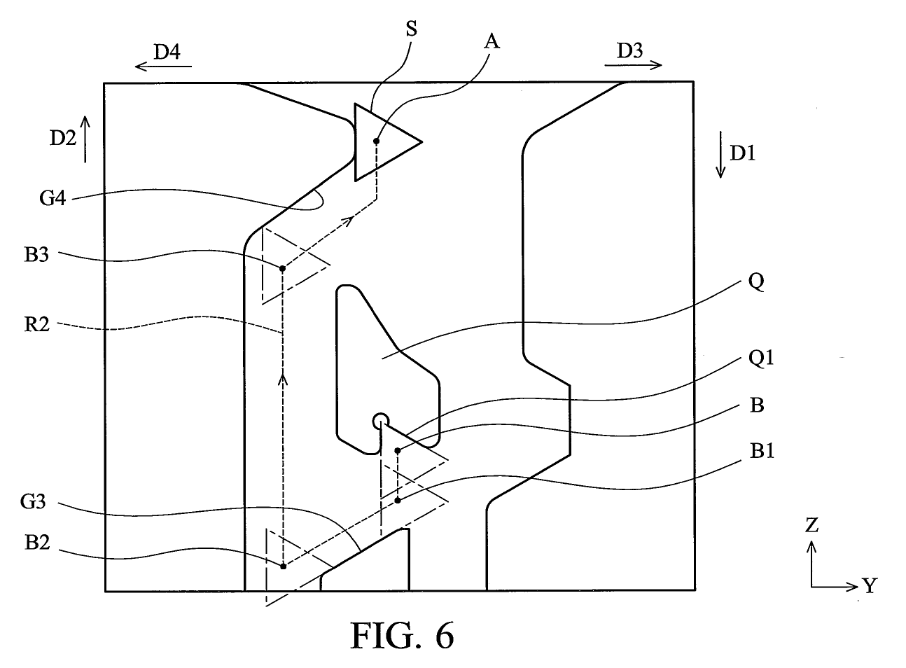

When the support 10 returns from the retracted state to the normal state, the slider S moves from the joining position B to the original position A, as shown in FIG. 6. First, the sliding member 102 is impelled by the second force along the first direction D1 when in the retracted state, such that the slider S descends from the recess Q1 (the joining position B) to position B1. Subsequently, a third slope G3 of the fixed member 101 guides the slider S from position B1 to position B2 along the second path R2, with horizontal movement in the fourth direction D4.

When the second force is released, the slider S is impelled upwards by the spring force F from the position B2 to position B3 along the second path R2. Finally, the slider S is guided by a fourth slope G4 of the fixed member 101 to the original position A, along the second path R2, such that the support 10 returns to the normal state.

Retractable supports are provided according to the embodiment. The support comprises a fixed member and a sliding member. The fixed member comprises a closed pathway and an engaging portion. A slider is movably disposed on the sliding member, corresponding to the closed pathway and the engaging portion. When the support is in a retracted state, the slider is restricted in a recess of the engaging portion by spring force. When the support is extended from the retracted state to a normal state, the slider is released from the recess by an external force and returned to an original position by the spring force. In some embodiments, the support may comprise a plurality of sliders, and correspondingly, the fixed member may comprise a plurality of closed pathways and engaging portions. The retractable support has a simple structure and is suitable for various flat displays.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A support, comprising:
a fixed member, comprising:
a pathway, comprising a first path and a second path;
an engaging portion formed neighboring the pathway, comprising a recess between the first and second paths;
a sliding member movable with respect to the fixed member;
a slider movable with respect to the sliding member, wherein when the sliding member is impelled in a first direction by a first force, the slider moves from an original position to the recess along the first path of the pathway; and
a resilient member, connecting the fixed member and the sliding member, wherein the slider is restricted in the recess by a spring force from the resilient member in a second direction, opposite to the first direction, and when the slider is released from the recess by a second force, the slider returns to the original position by the spring force along the second path.

2. The support as claimed in claim 1, wherein the fixed member has a first slope guiding the slider along the first path while the sliding member moves in the first direction.

3. The support as claimed in claim 1, wherein the fixed member has a second slope guiding the slider along the first path to the recess while the sliding member moves in the first direction.

4. The support as claimed in claim 1, wherein the fixed member has a third slope guiding the slider along the second path when the slider is released from the recess by the second force.

5. The support as claimed in claim 1, wherein the fixed member has a fourth slope guiding the slider along the second path to the original position.

6. The support as claimed in claim 1, wherein the slider is movable in a third direction, perpendicular to the first direction.

7. The support as claimed in claim 6, wherein the sliding member comprises a guiding rail, parallel to the third direction, with the slider movably disposed therein.

8. The support as claimed in claim 1, wherein the fixed member comprises a plurality of pathways and engaging portions on an inner surface thereof.

9. The support as claimed in claim 8, wherein the support comprises a plurality of sliders, corresponding to the pathways and engaging portions.

10. The support as claimed in claim 1, wherein the resilient member comprises a constant force spring.

11. A support, comprising:
a fixed member, comprising:
a pathway, comprising a first path and a second path;
an engaging portion formed neighboring the pathway, comprising a recess formed between the first and second paths;
a sliding member movably connected to the fixed member, wherein the sliding member is movable toward a first direction when driven by an external force;
a slider movably connected to the sliding member; and
a resilient member, connecting the fixed member and the sliding member and exerting a spring force on the sliding member toward a second direction, the second direction being substantially opposite to the first direction;
wherein when the slider is situated in the first path of the pathway and the external force exceeds the spring force, the sliding member is impelled to move toward the first direction, and the slider driven by the sliding member moves from an original position to the recess along the first path;
wherein when the slider is situated in the recess and the spring force exceeds the external force, the sliding member is driven to move toward the second direction and the slider is engaged with the recess;
wherein when the slider is situated in the recess and the external force exceeds the spring force, the sliding member is driven to move toward the first direction, and the slider driven by the sliding member is released from the recess and enters the second path of the pathway;
wherein when the slider is situated in the second path and the spring force exceeds the external force, the sliding member is driven to move toward the second direction, and the slider driven by the sliding member moves to the original position along the second path.

12. The support as claimed in claim 11, wherein the fixed member has a first slope guiding the slider along the first path while the sliding member moves in the first direction.

13. The support as claimed in claim 11, wherein the fixed member has a second slope guiding the slider along the first path to the recess while the sliding member moves in the first direction.

14. The support as claimed in claim 11, wherein the fixed member has a third slope guiding the slider along the second path when the slider is released from the recess.

15. The support as claimed in claim 11, wherein the fixed member has a fourth slope guiding the slider along the second path to the original position.

16. The support as claimed in claim 11, wherein the slider is movable perpendicular to the first direction.

17. The support as claimed in claim 16, wherein the sliding member comprises a guiding rail with the slider movably disposed therein, perpendicular to the first direction.

18. The support as claimed in claim 11, wherein the fixed member comprises a plurality of pathways and engaging portions on an inner surface thereof.

19. The support as claimed in claim 18, wherein the support comprises a plurality of sliders, corresponding to the pathways and engaging portions.

20. The support as claimed in claim 11, wherein the resilient member comprises a constant force spring.
